(19) United States
(12) Patent Application Publication
(10) Pub. No.: US 2020/0149895 A1
(43) Pub. Date: May 14, 2020

(54) TRANSFER GUIDING DEVICE AND TRANSFER GUIDING METHOD

(71) Applicant: TOYOTA JIDOSHA KABUSHIKI KAISHA, Toyota-shi (JP)

(72) Inventors: Yoshihiro OE, Nissin-shi (JP); Michio IKEDA, Nagoya-shi (JP); Kohei UEZATO, Nissin-shi (JP); Masashi YAMADA, Aisai-shi (JP); Kenichi KOMURO, Nagoya-shi (JP); Toshiaki NIWA, Okazaki-shi (JP)

(73) Assignee: TOYOTA JIDOSHA KABUSHIKI KAISHA, Toyota-shi (JP)

(21) Appl. No.: 16/683,786

(22) Filed: Nov. 14, 2019

(30) Foreign Application Priority Data
Nov. 14, 2018 (JP) 2018-213681

(51) Int. Cl. G01C 21/26; G08G 1/005; G08G 1/13

(52) U.S. Cl. CPC G01C 21/26; G08G 1/13; G08G 1/005

(57) ABSTRACT

A transfer guiding device includes: a reception unit that receives a destination of a first vehicle used by a user; a search unit that searches for first and second routes along which the user travels from the first vehicle's current location to the destination respectively by the first vehicle and by the first and second vehicles; a calculation unit that calculates a first arrival time at which the user arrives at the destination by the first route, based on a first required time to travel through the first route, and a second arrival time at which the user arrives at the destination by the second route, based on a second required time to travel through the second route; and a transmission unit that transmits a message for recommending the user to transfer to the second vehicle when the first arrival time is later than the second arrival time.

### INCORPORATION BY REFERENCE

The disclosure of Japanese Patent Application No. 2018-213681 filed on Nov. 14, 2018 including the specification, drawings and abstract is incorporated herein by reference in its entirety.

### BACKGROUND

### 1. Technical Field

The disclosure relates to a transfer guiding device and a transfer guiding method.

### 2. Description of Related Art

Japanese Unexamined Patent Application Publication No. 2016-176903 (JP 2016-176903 A) discloses a technology for providing evaluation information based on which a user selects a desired means of transportation from various means of transportation, such as a taxi, a bus, and a car-sharing vehicle. The evaluation information includes an amount of time required to reach a destination, and traffic congestion information is taken into account in calculating the amount of time required to reach the destination.

### SUMMARY

In many cases, a fee for using a car-sharing vehicle is charged on an as-used basis, that is, charged based on a length time that a user uses the car-sharing vehicle. With this charging system, for example, if a user gets involved in a traffic congestion while using a car-sharing vehicle, the fee for using the car-sharing vehicle increases. City centers are dotted with congestion-prone sections (sections where traffic congestion often occurs). This may be an impediment to the widespread use of car-sharing.

The disclosure provides a transfer guiding device and a transfer guiding method that contribute to the promotion of the use of car-sharing.

A first aspect of the disclosure relates to a transfer guiding device including: a reception unit configured to receive a destination of a first vehicle that is used by a user as a car-sharing vehicle; a first search unit configured to search for a first route along which the user travels from a current location of the first vehicle to the destination by the first vehicle; a second search unit configured to search for a second route along which the user travels from the current location of the first vehicle to the destination by the first vehicle and a second vehicle that is smaller than the first vehicle and that is able to travel through a section impassable for the first vehicle; a first calculation unit configured to calculate a first arrival time at which the user arrives at the destination by the first route, based on a first required time required to travel through the first route; a second calculation unit configured to calculate a second arrival time at which the user arrives at the destination by the second route, based on a second required time required to travel through the second route; and a transmission unit configured to transmit a message for recommending the user to transfer to the second vehicle when the first arrival time is later than the second arrival time.

The transfer guiding device according to the first aspect may further include an acquisition unit configured to acquire road traffic information including information regarding a difficult-to-travel section that is present between the current location of the first vehicle and the destination. When a part of or an entirety of the difficult-to-travel section included in the road traffic information acquired by the acquisition unit overlaps with a part of or an entirety of the first route, the first calculation unit may calculate the first arrival time based further on a time required to pass through an overlapping section where the difficult-to-travel section overlaps with the first route. When a part of or an entirety of the difficult-to-travel section included in the road traffic information acquired by the acquisition unit overlaps with a part of the second route, the second calculation unit may calculate the second arrival time based further on a time required to pass through an overlapping section where the difficult-to-travel section overlaps with the second route.

In the first aspect, the difficult-to-travel section may include at least one of a congested section, a construction section, and an event holding section.

A second aspect of the disclosure relates to a transfer guiding method that is executed by a processor. The transfer guiding method includes: a reception step of receiving a destination of a first vehicle that is used by a user as a car-sharing vehicle; a first search step of searching for a first route along which the user travels from a current location of the first vehicle to the destination by the first vehicle; a second search step of searching for a second route along which the user travels from the current location of the first vehicle to the destination by the first vehicle and a second vehicle that is smaller than the first vehicle and that is able to travel through a section impassable for the first vehicle; a first calculation step of calculating a first arrival time at which the user arrives at the destination by the first route, based on a first required time required to travel through the first route; a second calculation step of calculating a second arrival time at which the user arrives at the destination by the second route, based on a second required time required to travel through the second route; and a transmission step of transmitting a message for recommending the user to transfer to the second vehicle when the first arrival time is later than the second arrival time.

According to the foregoing aspects of the disclosure, it is possible to provide the transfer guiding device and the transfer guiding method that contribute to the promotion of the use of car-sharing.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a car-sharing system including a management server; and

FIG. 2 is a flowchart illustrating an example of an operation of the management server illustrated in FIG. 1.

### DETAILED DESCRIPTION OF EMBODIMENTS

Hereinafter, an example embodiment of the disclosure will be described with reference to the accompanying drawings. Note that, elements denoted by the same reference signs in the drawings have the same or similar configurations.

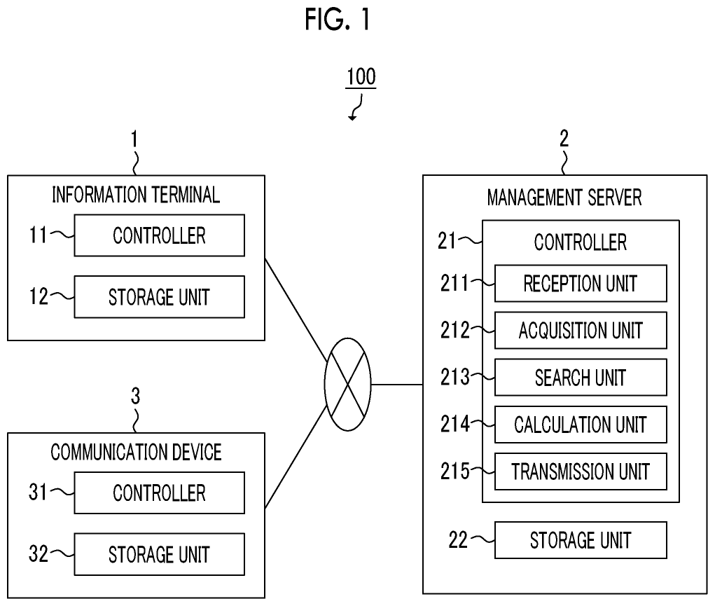

A configuration of a car-sharing system including a management server according to the present embodiment will be described with reference to FIG. 1. The management server is an example of “transfer guiding device”. A car-sharing system 100 includes an information terminal 1 carried by, for example, a user who uses a car-sharing service, a communication device 3 mounted in a vehicle used for car-sharing (hereinafter, referred to as “car-sharing vehicle”), and a management server 2 configured to manage users and car-sharing vehicles. The information terminal 1, the management server 2, and the communication device 3 are configured to communicate one another through networks including, for example, a wireless network.

Car-sharing vehicles in the present embodiment are classified into a first car-sharing vehicle (an example of “first vehicle”) and a second car-sharing vehicle (an example of “second vehicle”). Examples of first car-sharing vehicles include commonly-used four-wheeled automobiles, such as standard-sized automobiles, small-sized automobiles, and light automobiles. Second car-sharing vehicles are smaller than first car-sharing vehicles. Second car-sharing vehicles are able to travel through sections impassable for first car-sharing vehicles. Examples of second car-sharing vehicles include bicycles, and ultra-small-sized vehicles, such as one-person stand-up electric vehicles and one-person sit-down electric vehicles. Typical examples of ultra-small-sized vehicles include Winglet and Segway.

The car-sharing system 100 according to the present embodiment recommends a user who is using a first car-sharing vehicle to transfer to a second car-sharing vehicle, for example, in a case where there is a difficult-to-travel section, which is a section that is difficult for the first vehicle to travel through, on a route to the user's destination and the user can reach the destination earlier if the user transfers to the second car-sharing vehicle. Examples of difficult-to-travel sections include a congested section, a construction section, and an event holding section.

The information terminal 1 illustrated in FIG. 1 is, for example, a terminal device, such as a smartphone. The information terminal 1 includes, for example, a controller 11 and a storage unit 12, as functional elements. The information terminal 1 includes, for example, a controller including a central processing unit (CPU) and a memory, a manipulation unit, a display, a speaker, a storage unit, and a communication unit, as physical elements. The functions of the controller 11 and the storage unit 12 are implemented by the CPU executing predetermined programs stored in the memory.

The communication device 3 includes, for example, a controller 31 and a storage unit 32, as functional elements. The communication device 3 includes, for example, a controller including a CPU and a memory, a manipulation unit, a display, a speaker, a storage unit, and a communication unit, as physical elements. The functions of the controller 31 and the storage unit 32 are implemented by the CPU executing predetermined programs stored in the memory.

The management server 2 includes, for example, a controller 21 and a storage unit 22, as functional elements. The management server 2 includes, for example, a controller including a CPU and a memory, a storage unit, and a communication unit, as physical elements. The functions of the controller 21 and the storage unit 22 are implemented by the CPU executing predetermined programs stored in the memory.

The management server 2 stores, for example, user information regarding each user who uses a car-sharing service and vehicle information regarding each car-sharing vehicle in a database or the like, and manages the user information and the vehicle information.

The user information includes, for example, a user identification (ID) for identifying a user, the user's name, the user's contact address, and a vehicle ID of a car-sharing vehicle that is used by the user.

The vehicle information includes, for example, a vehicle ID for identifying a car-sharing vehicle, the vehicle model of the car-sharing vehicle, the current location of the car-sharing vehicle, and usage status information regarding the car-sharing vehicle. The usage status information regarding the car-sharing vehicle includes, for example, information indicating whether or not the car-sharing vehicle is being used by a user, the user ID of the user who is using the car-sharing vehicle, the use start time, the use start place, the scheduled return time, and the scheduled return place.

The management server 2 collects road traffic information including information regarding a difficult-to-travel section from, for example, a traffic information center as needed, stores the road traffic information in a database or the like, and manages the road traffic information.

The function of the controller 21 of the management server 2 will be described below in detail. The controller 21 includes, for example, a reception unit 211, an acquisition unit 212, a search unit 213, a calculation unit 214, and a transmission unit 215.

The reception unit 211 receives at least one of a destination of a first car-sharing vehicle that is used by a user and a current location of the first car-sharing vehicle. The destination of the first car-sharing vehicle is input by the user with the use of, for example, the information terminal 1 carried by the user or the communication device 3 mounted in the first car-sharing vehicle, and is then transmitted to the management server 2 from the information terminal 1 or the communication device 3. The current location of the first car-sharing vehicle is measured through the use of, for example, a global positioning system (GPS) function installed in the information terminal 1 or the communication device 3, and is then transmitted to the management server 2. The current location may be transmitted, for example, periodically or at specific timings.

The acquisition unit 212 acquires, from the database, information regarding a difficult-to-travel section that is present between the current location of the first car-sharing vehicle and the destination.

The search unit 213 (an example of “first search unit”) searches for a route along which the user travels from the current location of the first car-sharing vehicle to the destination by the first car-sharing vehicle (hereinafter, such a route will be referred to as “first route”).

The search unit 213 (an example of “second search unit”) searches for a route along which the user travels from the current location of the first car-sharing vehicle to the destination by the first car-sharing vehicle and a second car-sharing vehicle (hereinafter, such a route will be referred to as “second route”). The second car-sharing vehicle is parked at, for example, a port or a station. Therefore, the effects of transferring to the second car-sharing vehicle can be further enhanced by providing a port or a station, where the second car-sharing vehicle can be parked, near a place where a difficult-to-travel section is expected to be generated.

The calculation unit 214 (an example of “first calculation unit”) calculates a time at which the user arrives at the destination by the first route (hereinafter, referred to as “first arrival time”), based on an amount of time required to travel through the first route (hereinafter, referred to as “first required time”). When a part of or the entirety of the difficult-to-travel section included in the information acquired by the acquisition unit 212 overlaps with a part of or the entirety of the first route, the calculation unit 214 calculates the first arrival time based further on an amount of time required to travel (pass) through an overlapping section where the difficult-to-travel section overlaps with the first route (hereinafter, referred to as “first difficult-to-travel section traveling time”).

The calculation unit 214 (an example of “second calculation unit”) calculates a time at which the user arrives at the destination by the second route (hereinafter, referred to as “second arrival time”) based on an amount of time required to travel through the second route (hereinafter, referred to as “second required time”). When a part of or the entirety of the difficult-to-travel section included in the information acquired by the acquisition unit 212 overlaps with a part of the second route, the calculation unit 214 calculates the second arrival time based further on an amount of time required to travel (pass) through an overlapping section where the difficult-to-travel section overlaps with the second route (hereinafter, referred to as “second difficult-to-travel section traveling time”).

When the first arrival time is later than the second arrival time, the transmission unit 215 transmits a message for recommending the user to the transfer to the second car-sharing vehicle. The message for recommending the user to the transfer to the second car-sharing vehicle may be transmitted to, for example, the information terminal 1 carried by the user or the communication device 3 mounted in the first car-sharing vehicle.

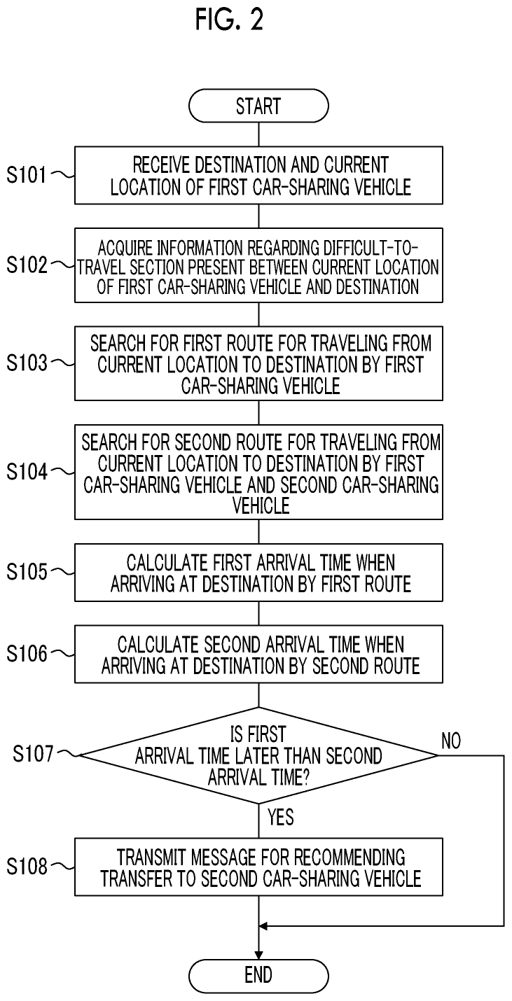

With reference to FIG. 2, an example of an operation of the management server 2 in the present embodiment will be described. A series of procedures in this operation is performed when the use of a first car-sharing vehicle is started. Alternatively, the series of procedures may be repeatedly executed while a user is using the first car-sharing vehicle.

First, the reception unit 211 of the management server 2 receives a destination of the first car-sharing vehicle that is used by the user and a current location of the first car-sharing vehicle (step S101).

Subsequently, the acquisition unit 212 of the management server 2 acquires, from the database, information regarding a difficult-to-travel section that is present between the current location of the first car-sharing vehicle and the destination (step S102).

Subsequently, the search unit 213 of the management server 2 searches for a first route along which the user travels from the current location of the first car-sharing vehicle to the destination by the first car-sharing vehicle (step S103).

Subsequently, the search unit 213 of the management server 2 searches for a second route along which the user travels from the current location of the first car-sharing vehicle to the destination by the first car-sharing vehicle and the second car-sharing vehicle (step S104).

Subsequently, the calculation unit 214 of the management server 2 calculates a first arrival time at which the user arrives at the destination by the first route, based on a first required time and a first difficult-to-travel section traveling time (step S105).

Subsequently, the calculation unit 214 of the management server 2 calculates a second arrival time at which the user arrives at the destination by the second route, based on a second required time and a second difficult-to-travel section traveling time (step S106).

Subsequently, the transmission unit 215 of the management server 2 determines whether the first arrival time is later than the second arrival time (step S107). When the transmission unit 215 makes a negative determination in step S107 (NO in step S107), this operation ends.

On the other hand, when the transmission unit 215 of the management server 2 determines in step S107 that the first arrival time is later than the second arrival time (YES in step S107), the transmission unit 215 transmits a message for recommending the user to the transfer to the second car-sharing vehicle (step S108). Then, the operation ends.

As described above, with the management server 2 in the present embodiment, it is possible to search for each of the first route along which the user travels from the current location of the first car-sharing vehicle to the destination by the first car-sharing vehicle and the second route along which the user travels from the current location of the first car-sharing vehicle to the destination by the first car-sharing vehicle and the second car-sharing vehicle. Further, it is possible to recommend the user to transfer to the second car-sharing vehicle, when the first arrival time at which the user arrives at the destination by the first route is later than the second arrival time at which the user arrives at the destination by the second route.

Thus, it is possible to recommend the user to the transfer to the second car-sharing vehicle, for example, in a case where a section impassable for the first car-sharing vehicle is present between the current location and the destination and the user can arrive at the destination earlier if the user transfers to the second car-sharing vehicle to travel through the section by the second car-sharing vehicle. Therefore, with the management server 2 in the present embodiment, it is possible to promote the use of car-sharing.

With the management server 2 in the present embodiment, it is possible to calculate the first arrival time using the first difficult-to-travel section traveling time when a part of or the entirety of the difficult-to-travel section that is present between the current location of the first car-sharing vehicle and the destination overlaps with a part of or the entirety of the first route, and it is possible to calculate the second arrival time using the second difficult-to-travel section traveling time when a part of or the entirety of the difficult-to-travel section overlaps with a part of the second route. Thus, it is possible to enhance the accuracy of calculating a predicted amount of time required to travel from the current location to the destination, even when there is a difficult-to-travel section that is difficult for the first car-sharing vehicle to travel through, such as a congested section, a construction section, or an event holding section, between the current location and the destination.

It should be noted that the disclosure is not limited to the foregoing embodiment, and may be implemented in various other embodiments within the scope of the disclosure. Thus, the foregoing embodiment is to be considered in all respects as illustrative and not restrictive. For example, the order of executing the foregoing processing steps may be changed or the foregoing processing steps may be executed in parallel as long as no technical contradiction occurs.

The elements of each of the information terminal 1, the management server 2, and the communication device 3 are not limited to the elements in the foregoing embodiment, and any elements may be added as needed. Further, the functions of the management server 2 need not be implemented by a single server device, and the functions may be implemented respectively by two or more server devices.

What is claimed is:

1. A transfer guiding device comprising:
a reception unit configured to receive a destination of a first vehicle that is used by a user as a car-sharing vehicle;
a first search unit configured to search for a first route along which the user travels from a current location of the first vehicle to the destination by the first vehicle;
a second search unit configured to search for a second route along which the user travels from the current location of the first vehicle to the destination by the first vehicle and a second vehicle that is smaller than the first vehicle and that is able to travel through a section impassable for the first vehicle;
a first calculation unit configured to calculate a first arrival time at which the user arrives at the destination by the first route, based on a first required time required to travel through the first route;
a second calculation unit configured to calculate a second arrival time at which the user arrives at the destination by the second route, based on a second required time required to travel through the second route; and
a transmission unit configured to transmit a message for recommending the user to transfer to the second vehicle when the first arrival time is later than the second arrival time.

2. The transfer guiding device according to claim 1, further comprising an acquisition unit configured to acquire road traffic information including information regarding a difficult-to-travel section that is present between the current location of the first vehicle and the destination, wherein
when a part of or an entirety of the difficult-to-travel section included in the road traffic information acquired by the acquisition unit overlaps with a part of or an entirety of the first route, the first calculation unit calculates the first arrival time based further on a time required to pass through an overlapping section where the difficult-to-travel section overlaps with the first route, and
when a part of or an entirety of the difficult-to-travel section included in the road traffic information acquired by the acquisition unit overlaps with a part of the second route, the second calculation unit calculates the second arrival time based further on a time required to pass through an overlapping section where the difficult-to-travel section overlaps with the second route.

3. The transfer guiding device according to claim 2, wherein the difficult-to-travel section includes at least one of a congested section, a construction section, and an event holding section.

4. A transfer guiding method that is executed by a processor, the transfer guiding method comprising:
a reception step of receiving a destination of a first vehicle that is used by a user as a car-sharing vehicle;
a first search step of searching for a first route along which the user travels from a current location of the first vehicle to the destination by the first vehicle;
a second search step of searching for a second route along which the user travels from the current location of the first vehicle to the destination by the first vehicle and a second vehicle that is smaller than the first vehicle and that is able to travel through a section impassable for the first vehicle;
a first calculation step of calculating a first arrival time at which the user arrives at the destination by the first route, based on a first required time required to travel through the first route;
a second calculation step of calculating a second arrival time at which the user arrives at the destination by the second route, based on a second required time required to travel through the second route; and
a transmission step of transmitting a message for recommending the user to transfer to the second vehicle when the first arrival time is later than the second arrival time.
